(19) United States
(12) Patent Application Publication
(10) Pub. No.: US 2004/0049482 A1
(43) Pub. Date: Mar. 11, 2004

(54) Methods and systems for intellectual property management

(76) Inventors: Ralf Brechter, Mannheim (DE); Frank Von Appen, Nussloch (DE); Manfred Gaertner, Wiesloch (DE)

Correspondence Address: FINNEGAN, HENDERSON, FARABOW, GARRETT & DUNNER, LLP, 1300 I STREET, NW, WASHINGTON, DC, 20005, US

(21) Appl. No.: 10/415,596

(22) PCT Filed: Oct. 30, 2001
(86) PCT No.: PCT/EP01/12529

(51) Int. Cl. G06F 7/00

(52) U.S. Cl. 707/1

(57) ABSTRACT

Method and system for managing intellectual property rights use a first computer (901) with database (210), template documents (220), final documents (230). The database (210) has representations of works (W), representations of applicable rights (R), and states (S). The first computer (901) communicates with a second computer (902) to derive the final documents (230)—such as license contracts—from templates (220). A functional statement (F) in the final document (230) relates the representations to the applicable right. The statement is also used to calculate indicators—such as royalties—to be forwarded to a third computer (903).

### FIELD OF THE INVENTION

The present invention generally relates to data processing and, more particularly, relates to computer systems, computer programs, and methods that manage intellectual property rights.

### BACKGROUND OF THE INVENTION

Authors are active in almost all areas of human activity. For example, writers write books; photographers make photos; directors and actors create movies; or composers and musicians make music. Modern computer technology allows availability of the works in digital form. To stay with the example: the texts of the books are stored in text files; photos and paintings are scanned to picture files; the movies have the form of audio and video streams; and so on.

Besides the works (i.e. books, photos, movies, music), applicable law establishes rights on the works, such as copyright. The combination of work and right—also referred to as “asset”—is the main income source for the author. The author may sell the original work once, but the author receives the major part of income when the work recipient (i.e. book reader) pays for a copy of the work.

Without the intention to cover all legal aspects for all jurisdictions, the explanation is simplified to the technical aspects under the following scenario: The authors assign rights to others, or grants licenses to others, usually to media companies, such as publishing houses. In most of the cases, the author receives payment, for example, royalties.

The stay with the example, the publisher sells copies to the readers and returns a portion of the book price to the writer as royalty.

The rights and royalties are technically represented, for example, by entries in databases. However, the value chain from author via publisher to recipient is far more complex. It involves to technically further represent:

documents (e.g., license contracts),

time aspects (e.g., expiration of rights),

billing aspects (e.g., calculating royalties),

authentication and validity aspects (e.g., providing authorized copies),

territorial aspects (rights in different countries), and so on. There is an ongoing need to provide an improved right management system.

The following references are useful:

U.S. Pat. No. 5,900,608 and U.S. Pat. No. 6,209,787 both by Iida,

U.S. Pat. No. 5,933,498 to Schneck et al.

U.S. Pat. No. 5,634,012 to Stefik et al.,

U.S. Pat. No. 5,247,575 to Sprague et al.,

U.S. Pat. No. 5,765,152 to Erickson,

U.S. Pat. No. 4,977,594 to Shear,

WO 93/01550,

WO 99/45491,

WO 98/42098,

WO 00/21239,

WO 00/44119,

WO 00/58811

Jon Bing: “Convergence—and Some Possible Consequences for Copyright and Right Holders” in: “Computer und Recht 4/2001, pages 104-111”.

### SUMMARY OF THE INVENTION

The present invention relates to a method for managing rights that relate to works. The method comprises the following steps: (1) providing on a first computer a database with representations of the works, with representations of applicable rights for the works, and with states; (2) for a given work, selecting a template document that corresponds to the representation of the right for the work; (3) communicating between the first computer and a second computer to derive a final document from the template document, the final document having a functional statement using a first indicator going into the first computer and using a second indicator, the final document being associated with the database and relating the representations of the work and of the right, the states and the functional statement; (4) setting the state to active; (5) receiving the first indicator from a third computer; (6) calculating the second indicator according to the functional statement); and (7) forwarding the second indicator to the second computer.

Preferably, distributing a copy of the work follows setting. This is convenient when the data also stores the work itself. On-demand publishing or similar services are supported.

Preferably, in the receiving step, the first indicator is a numerical value representing a quantity selected from the group of: number of physical copies of the work, number of broadcast transmissions of the work, time the physical copy of the work is available to a predetermined customer, and the number of subscribers to copies of the work.

Preferably, the second indicator is a numerical value representing a quantity selected from the group of: royalty (i.e., license fee), agent fee, and commission.

Preferably, further steps are added, selected from the group of: acquiring a right (e.g., by a media company from an author), selling a right (e.g., to a customer), managing a contract that relates to a right (e.g., modifying the contract to change the functional statement), checking availability of a right (e.g., right depends on further rights, right hierarchy), checking two rights for collision and non-collision, checking expiration and existence of a right (e.g., expiration by virtue of law or by virtue of contract terms), checking contractual or statutory restrictions (e.g., checking against predefined criteria that are stored in the database), tracking utilization of a right (e.g., receiving indicators when the right is exercised), alerting upon reaching a predefined threshold of the first or the second indicators (e.g., causing contract change, or modifying the functional statement, convenient for contracts that use the threshold), reporting, electronically presenting bills and payment through Internet (e.g., convenient for e-WO commerce with rights), delaying step setting active by a predetermined delay time (e.g., preventing from forwarding copies after the right has expired), and periodically triggering payment (e.g., automatically triggering payment according to a contract, such as for contracts with monthly or weekly payment).

Optionally, the method further comprises the step triggering a workflow in the first computer to obtain legal clearance if a predefined condition is detected (e.g., upon detecting a right collision, forwarding an alert message to an attorney). Workflows are predefined sequences of program calls in computer systems.

Optionally, the method comprises the step parsing the database to detect events. The events are predefined, such as: the first indicator has passed a predetermined threshold (e.g., sale reaches a certain number of copies), a right is changed but shipping a physical copy to a customer is ongoing (conflict detected).

Preferably, during parsing the database, events are detected that have representations in the final document. This is convenient, for example, if the threshold is stored in the final document.

Optionally is also the step of triggering shipment of a copy to a customer. Shipment comprises an action selected from the group of: shipping a physical copy of the work to a customer (e.g., sending a compact disc) and broadcasting the work (e.g., via radio or television).

Optionally, reading from the third computer is performed by from a computer that is related to a recipient of the work. The third computer is installed, for example, at a radio station, at a broadcaster, at a discotheque, at a cinema, at a restaurant, at a distributor, at a media agency, or at the home of a customer who accesses the copy of the work via Internet.

Preferably, the rights that are managed according to the method comprise at least one of: reproduction right, broadcasting right, public performance right, adaptation right, translation right, public recitation right, public display right, distribution right, and sales right. Optionally, one right depends on a further right. Optionally, the rights are classified into categories with attributes.

Preferably, the template document and the final document comprise a contract of at least one of the following types: sales contract, purchase contract, and license contract. Optionally, the contract is related to a further contract, selected from the group of: addendum, extension, side-letter, and contract that merges existing contracts.

Preferably, the method is performed by the first computer being a computer of a media company, and the second computer being a computer of a financial organization (e.g., a bank).

It is convenient to implement the method by accessing the followings customer relationship management (CRM) functions: sales organization, sales group, sales offices, service organization, purchasing organization, and purchasers group. These functions are commercially available from SAP Aktiengesellschaft, Walldorf (Baden), Germany, (hereinafter SAP AG).

Preferably, calculating the functional statement comprises any function of the following: deactivating the state when the first indicator exceeds a redetermined number (e.g., to prevent the distribution of unauthorized copies is a threshold is reached), deactivating the state after a predetermined time from activating (e.g., defined in the contract that is represented by the final document), or deactivating the state after a right has expired.

Preferably, the work is a digital work and the copy of the work is also a digital copy. This is convenient, but not essential; analog techniques can be used as well.

The present invention also related to the contract produced as the final document by the practice of the method. Also, the present invention relates to a computer-based system, computer-program product and article of manufacture with a computer readable medium for executing the method as defined in claim 1 and the dependent claims. Details for system, program and article are explained at the end of the detailed description.

The present invention has a variety of useful functions, for example:

The system automatically collects royalties for copyrights or the like.

The system centralizes functions such as customer relationship management (CRM), business warehouse (BW), and billing engine by a central database.

It is an advantage that the system of the present invention uses existing data definitions that fit into existing business software by SAP AG. Such business software is usually summarized as a “solution map” with the following:

Software “Customer Relationship Management” with components such as “Customer Service”, “Market Research & Analysis”, “Product/Brand Marketing”, “Marketing Program Management” and “Sales Management”.

Software “Production” with components such as “Media Content Planning”, “Media Production Planning”, “Media Production Controlling”, “Media Object Editing”, and “Composing Activity Recording”.

Software “Publication” with components such as “Publication Planning”, “Printing”, “Broadcasting”, “Online Publishing”, and “CD ROM Manufacturing”.

Software “Sales Cycle Management” with components such as “Advertising”

Software “Business Partner Management” with components such as “Sales Order Management”, “Billing/Invoicing”, “Contract Management” and “Settlements”

System and method of the invention partially use functions of the above software. The invention goes into future software “Media Asset Management” with components such as “Media Asset Procurement”, “Content Management”, “Rights Management” and “Royalty Accounting”

### BRIEF DESCRIPTION OF THE DRAWINGS

FIG. 1 is a simplified block diagram of an inventive computer system;

FIG. 2 is a simplified block diagram of the system with more details;

FIG. 3 is a simplified diagram of a database in the system of FIG. 2;

FIG. 4 is a simplified table with exemplary types of rights;

FIG. 5 is a simplified table with categories;

FIG. 6 is a simplified asset table;

FIG. 7 is a simplified structure diagram of a template document;

FIG. 8 is a simplified structure diagram of a final document that is derived from the template document; and

FIG. 9 is a simplified flow chart diagram of a method of the present invention.

### COMPUTER NETWORK SYSTEM

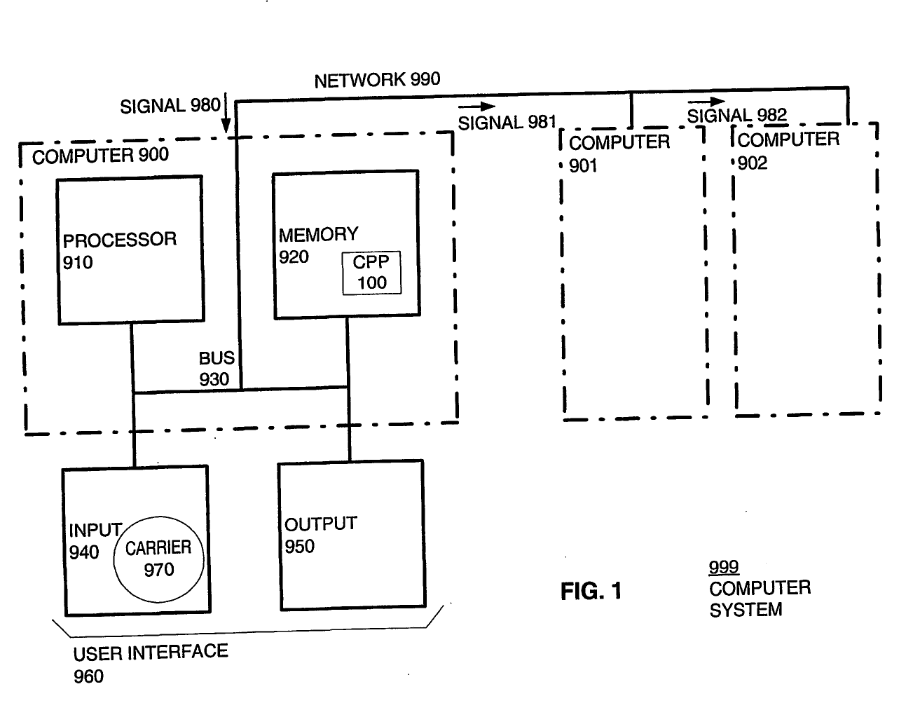

FIG. 1 illustrates a simplified block diagram of the inventive computer network system 999 having a plurality of computers 900, 901, 902 (or 90q, with q=0 . . . Q-1, Q any number).

Computers 900-902 are coupled via inter-computer network 990. Computer 900 comprises processor 910, memory 920, bus 930, and, optionally, input device 940 and output device 950 (I/O devices, user interface 960). As illustrated, the invention is present by computer program product 100 (CPP), program carrier 970 and program signal 980, collectively “program”.

In respect to computer 900, computer 901/902 is sometimes referred to as “remote computer”, computer 901/902 is, for example, a server, a router, a peer device or other common network node, and typically comprises many or all of the elements described relative to computer 900. Hence, elements 100 and 910-980 in computer 900 collectively illustrate also corresponding elements 10q and 91q-98q (shown for q=0) in computers 90q.

Computer 900 is, for example, a conventional personal computer (PC), a desktop and hand-held device, a multiprocessor computer, a pen computer, a microprocessor-based or programmable consumer electronics, a minicomputer, a mainframe computer, a personal mobile computing device, a mobile phone, a portable or stationary personal computer, a palmtop computer or the like.

Processor 910 is, for example, a central processing unit (CPU), a micro-controller unit (MCU), digital signal processor (DSP), or the like.

Memory 920 symbolizes elements that temporarily or permanently store data and instructions. Although memory 920 is conveniently illustrated as part of computer 900, memory function can also be implemented in network 990, in computers 901/902 and in processor 910 itself (e.g., cache, register), or elsewhere. Memory 920 can be a read only memory (ROM), a random access memory (RAM), or a memory with other access options. Memory 920 is physically implemented by computer-readable media, such as, for example: (a) magnetic media, like a hard disk, a floppy disk, or other magnetic disk, a tape, a cassette tape; (b) optical media, like optical disk (CD-ROM, digital versatile disk—DVD); (c) semiconductor media, like DRAM, SRAM, EPROM, EEPROM, memory stick, or by any other media, like paper.

Optionally, memory 920 is distributed across different media. Portions of memory 920 can be removable or non-removable. For reading from media and for writing in media, computer 900 uses devices well known in the art such as, for example, disk drives, tape drives.

Memory 920 stores support modules such as, for example, a basic input output system (BIOS), an operating system (OS), a program library, a compiler, an interpreter, and a text-processing tool. Support modules are commercially available and can be installed on computer 900 by those of skill in the art. For simplicity, these modules are not illustrated.

CPP 100 comprises program instructions and—optionally—data that cause processor 910 to execute method steps of the present invention. Method steps are explained with more detail below. In other words, CPP 100 defines the operation of computer 900 and its interaction in network system 999. For example and without the intention to be limiting, CPP 100 can be available as source code in any programming language, and as object code (“binary code”) in a compiled form. Persons of skill in the art can use CPP 100 in connection with any of the above support modules (e.g., compiler, interpreter, operating system).

Although CPP 100 is illustrated as being stored in memory 920, CPP 100 can be located elsewhere. CPP 100 can also be embodied in carrier 970.

Carrier 970 is illustrated outside computer 900. For communicating CPP 100 to computer 900, carrier 970 is conveniently inserted into input device 940. Carrier 970 is implemented as any computer readable medium, such as a medium largely explained above (cf. memory 920). Generally, carrier 970 is an article of manufacture comprising a computer readable medium having computer readable program code means embodied therein for executing the method of the present invention. Further, program signal 980 can also embody computer program 100. Signal 980 travels on network 990 to computer 900.

Having described CPP 100, program carrier 970, and program signal 980 in connection with computer 900 is convenient. Optionally, program carrier 971/972 (not shown) and program signal 981/982 embody computer program product (CPP) 101/102 to be executed by processor 911/912 (not shown) in computers 901/902, respectively.

Input device 940 symbolizes a device that provides data and instructions for processing by computer 900. For example, device 940 is a keyboard, a pointing device (e.g., mouse, trackball, cursor direction keys), microphone, joystick, game pad, scanner, disc drive. Although the examples are devices with human interaction, device 940 can also operate without human interaction, such as, a wireless receiver (e.g., with satellite dish or terrestrial antenna), a sensor (e.g., a thermometer), a counter (e.g., goods counter in a factory). Input device 940 can serve to read carrier 970.

Output device 950 symbolizes a device that presents instructions and data that have been processed. For example, a monitor or a display, (cathode ray tube (CRT), flat panel display, liquid crystal display (LCD), speaker, printer, plotter, vibration alert device. Similar as above, output device 950 communicates with the user, but it can also communicate with further computers.

Input device 940 and output device 950 can be combined to a single device; any device 940 and 950 can be provided optional.

Bus 930 and network 990 provide logical and physical connections by conveying instruction and data signals. While connections inside computer 900 are conveniently referred to as “bus 930”, connections between computers 900-902 are referred to as “network 990”. Optionally, network 990 comprises gateways being computers that specialize in data transmission and protocol conversion.

Devices 940 and 950 are coupled to computer 900 by bus 930 (as illustrated) or by network 990 (optional). While the signals inside computer 900 are mostly electrical signals, the signals in network are electrical, magnetic, optical or wireless (radio) signals.

Networking environments (as network 990) are commonplace in offices, enterprise-wide computer networks, intranets and the Internet (i.e. world wide web). The physical distance between a remote computer and computer 900 is not important. Network 990 can be a wired or a wireless network. To name a few network implementations, network 990 is, for example, a local area network (LAN), a wide area network (WAN), a public switched telephone network (PSTN); a Integrated Services Digital Network (ISDN), an infra-red (IR) link, a radio link, like Universal Mobile Telecommunications System (UMTS), Global System for Mobile Communication (GSM), Code Division Multiple Access (CDMA), or satellite link.

Transmission protocols and data formats are known, for example, as transmission control protocol/internet protocol (TCP/IP), hyper text transfer protocol (HTTP), secure HTTP, wireless application protocol, unique resource locator (URL), a unique resource identifier (URI), hyper text markup language HTML, extensible markup language (XML), extensible hyper text markup language (XHTML), wireless application markup language (WML), Standard Generalized Markup Language (SGML) etc.

Interfaces coupled between the elements are also well known in the art. For simplicity, interfaces are not illustrated. An interface can be, for example, a serial port interface, a parallel port interface, a game port, a universal serial bus (USB) interface, an internal or external modem, a video adapter, or a sound card.

Computer and program are closely related. As used hereinafter, phrases, such as “the computer provides” and “the program provides”, are convenient abbreviations to express actions by a computer that is controlled by a program.

### DETAILED DESCRIPTION OF THE INVENTION

For convenience, of glossary of terms and a reference list are provided prior to the claims.

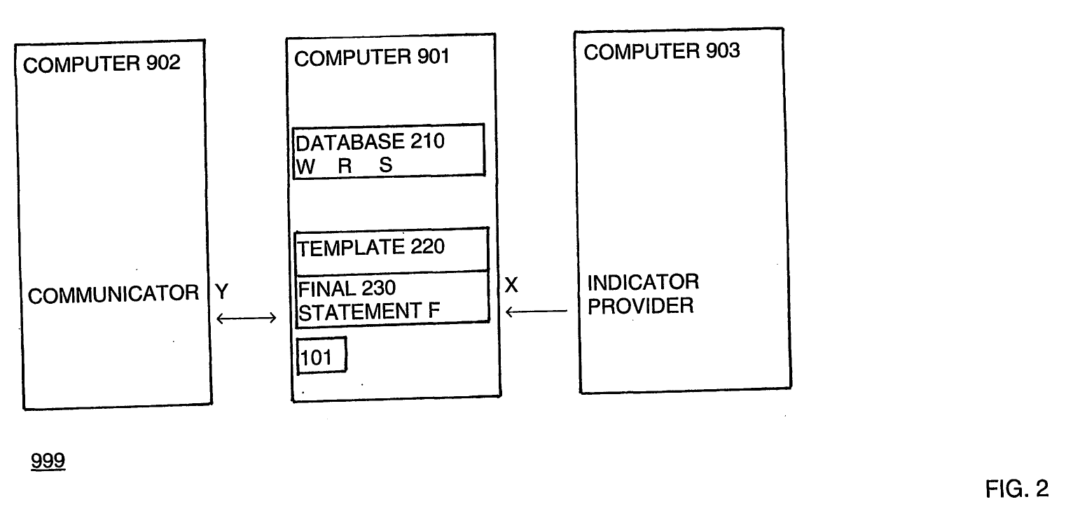

FIG. 2 is a simplified block diagram of system 999 with more details. System 999 comprises: first computer 901 (with database 210, template 220, and final document 230), second computer 902 with a communicator, and third computer 903 with an indicator provider.

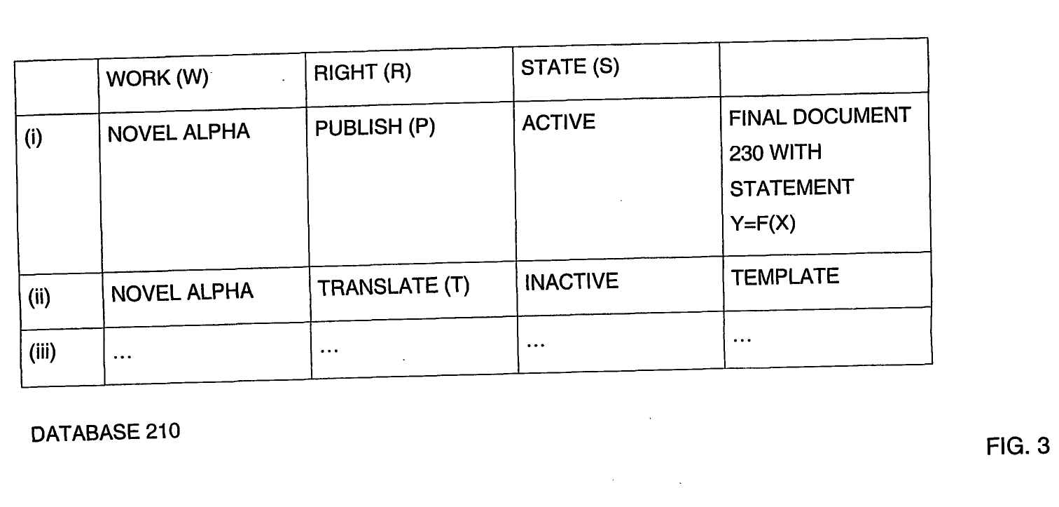

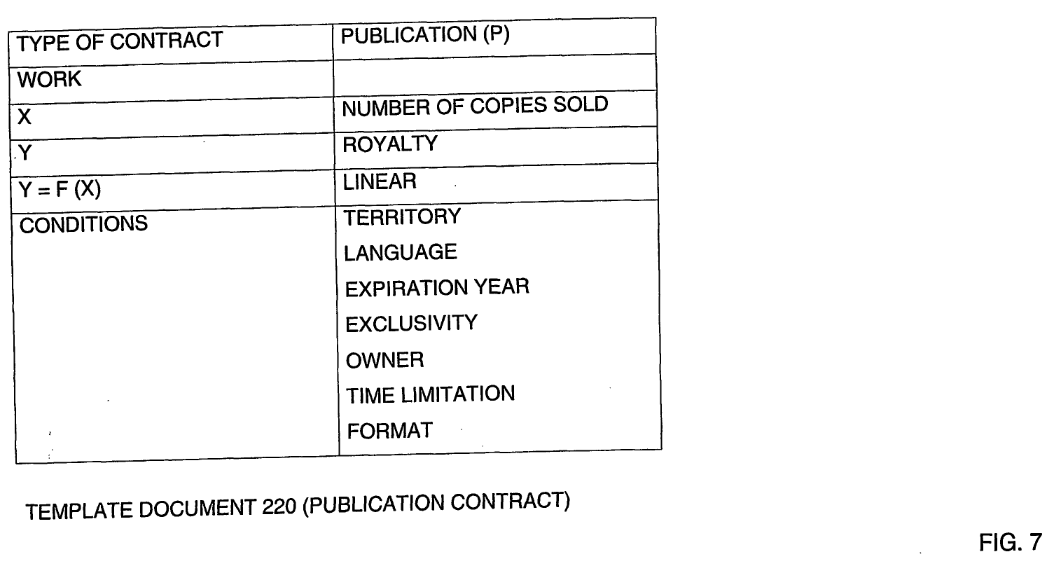

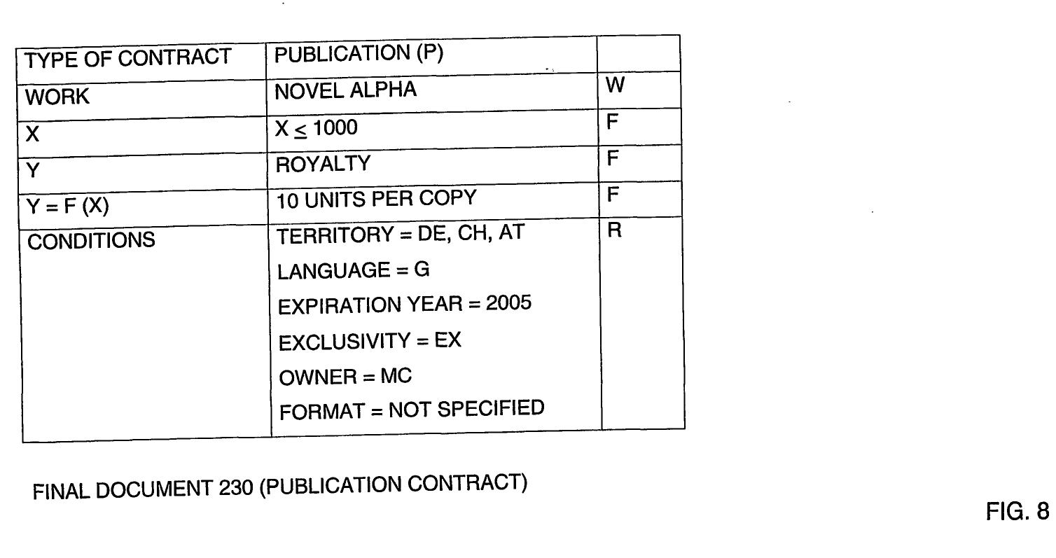

System 999 is a system for managing rights that relate to works. Database 210 has representations of the works W, representations of applicable rights R for the works, and states S, details in FIG. 3. For a given work (e.g. novel ALPHA), computer 901 selects template document 220 that corresponds to the representation of the right R for the work W. Computer 901 and computer 902 communicate to derive final document 230 from template document 220 (details in FIGS. 7-8). Final document 230 has a functional statement Y=F(X), with first indicator X going into computer 901 (cf. arrow from computer 903) and with second indicator Y. Final document 230 is associated with database 210 and relates the representations of work W, R, and S with the functional statement F. Upon deriving document 230, computer 901 sets state S to active, receives first indicator X from computer 903, calculates second indicator Y according to the statement F, and forwards second indicator Y to computer 902.

The computer-program product (according to the invention) on computer 901 has reference number 101.

FIG. 3 is a simplified diagram of database 210 in the system of FIG. 2. Database 210 comprises representations of works (W), representations of applicable rights (R) for the works, and states (S) (illustrated in columns). During further processing, final document 230 (cf. FIGS. 2, 8) is added.

Work (W) and right (R) form assets; the state (S) indicates availability (if active) or non-availability (if inactive) of the asset; final document 230 with statement F (i.e., Y=F(X)) indicates how the asset is employed.

Since details for database 210 are explained in connection with the following figures, entries in FIG. 3 are simplified. As illustrated, publication of novel ALPHA (asset (i)) is activated according to conditions set out in document 230 (i.e. contract); translation of ALPHA (asset (ii)) is still inactive, a corresponding contract document is still absent. However, a template document is present that can be converted into a final document.

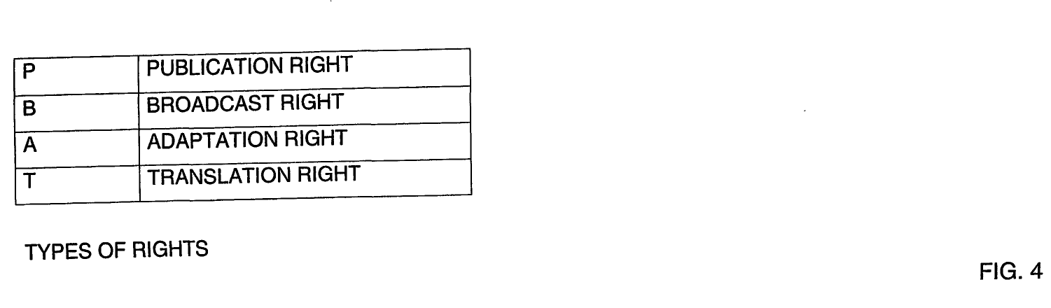

FIG. 4 is a simplified table with exemplary types of rights. There is no need to store the complete table in database 210. The acronyms P, B, A and T correspond to acronyms in column rights (R) of database 210.

The following examples for rights are given without the intention of referring to a particular law in a particular legislation. The rights are cited in simplified wording that that does not necessarily correspond to the wording of applicable law. By writing a novel, the author (“creator”) acquires a variety of exclusive rights, for example,

the right to distribute physical copies, e.g. to distribute books (hereinafter “publication right”);

the right to distribute the novel in non-physical form via radio, television or the like (hereinafter “broadcast right”);

the right to adapt the novel, for example to a movie (hereinafter “adaptation right”); and

the right to publish a translation (hereinafter “translation right”).

For convenience of explanation, it is assumed that by virtue of international treaties and conventions, the rights are international rights. Collectively, these rights are also referred to as “copyright”. Using copyrights only is convenient for explanation; persons of skill in the art can use the present invention also for other rights such as neighboring rights (“related rights”) or even patent rights.

The author can exercise each the rights alone or in combination, for example, for the following purposes:

use the work (or a copy) himself/herself,

permit someone else to use, or

prohibit someone else from using.

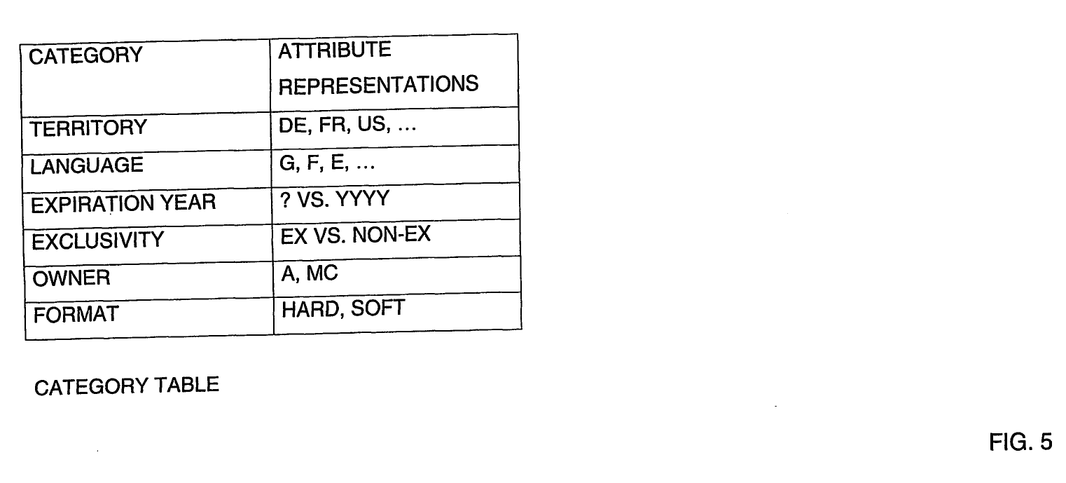

FIG. 5 is a simplified table with categories. The table is preferably stored as part of database 210 to technically represent the categories.

The categories conveniently divide some or all rights. Each category has a plurality of attributes. Categories are single-attribute categories (exactly one attribute per category) or multiple-attribute categories (one or more attributes per category). Technically, the attributes are stored, for example, as strings or as integer numbers. In the example of FIG. 5, the attributes are stores as string acronyms. Ellipsis indicates the presence of further attributes.

The following explanations are not necessarily part of the table:

Category TERRITORY The acronyms are standard acronyms used by the Patent Cooperation Treaty for identifying countries or regions (e.g., DE for Germany, FR for France, US for the United States).

Category LANGUAGE The language does not necessarily correspond to the country. One language can be applicable for two countries (e.g., in German in DE and CH).

Category EXPIRATION If known, the expiration year can be calculated, for example according to rules predefined by law (e.g., 70 year pma) or introduced into the table (e.g., if a contract defines the expiration).

Category EXCLUSIVITY This category has a single attribute, that is either EX for “exclusive” or NON-EX for “non-exclusive”.

Category OWNER Indication of the right owner (“proprietor”), for example with the attributes author (“A”) or media company (“MC”).

Category FORMAT The right is available only for copies in a predefined format, for example, hardcover books or softcover books.

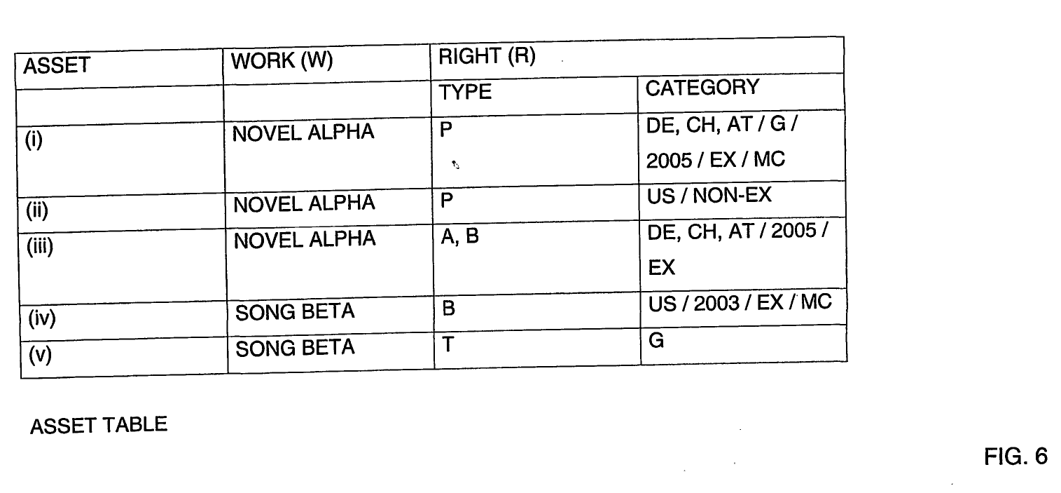

FIG. 6 is a simplified asset table, preferably part of database 210. As mentioned above, an asset is a combination of work and right, independent from the medium. Exemplary assets are given in rows (i) to (vi). The table column “right (R)” is divided into a column “type” (cf. FIG. 4) and a column “category” (cf. FIG. 5). Where applicable, the types are combined with one or more categories. Persons of skill in the art can provide filters that block undesired type-category combinations (e.g., “translation of music”)).

The table is explained in connection with the example of the novel ALPHA and the song BETA. The novel and the song belong to different work classifications, such as literary work and music work, respectively.

Asset (i) Novel ALPHA can be published (P) in Germany (DE), Switzerland (CH), Austria (AT), in German language (G), until 2005, and exclusively (EX) by the owner media company (MC).

Asset (ii) Novel ALPHA can be published (P) in the United States (US), non-exclusively (NON-EX). Language and the other categories remain unspecified.

Asset (iii) Novel ALPHA can be adapted (A) or broadcasted (B) in Germany (DE), Switzerland (CH), Austria (AT) until 2005 and exclusively (EX).

Asset (iv) Song BETA is available for broadcasting in the US until 2003 exclusively by the media company (MC).

Asset (v) A German (G) version of BETA is available as well.

FIG. 7 is a simplified structure diagram of template document 220. In the example, document 220 is a publication (P) contract that corresponds to assets (i) and (ii) of the asset table (FIG. 6, column “type”). The document structure is simplified illustrated as a matrix. The left column indicates placeholders for the contract items, such as type of contract, identification of work, type of first indicator X, type of second indicator Y, statement and conditions. The right column indicates default contract items, such as “publication contract” for the type, “number of copies” as the second indicator, “royalty” as the second indicator, a “linear function” for the statement (predefined royalty per copy), and categories (cf. FIG. 5) for contract conditions.

For convenience of explanation, text items and layout items such as a contract header (e.g., addresses of contract partners), further information (e.g., indication on the duration of the contract, deadlines), further conditions etc. are not illustrated.

During communication between computer 901 and computer 902, the template is converted to final document 230.

FIG. 8 is a simplified structure diagram of final document 230 that is derived from template document 220. Document 230 comprise technical representations for:

the type being a publication contract,

the work identification being “Novel ALPHA”,

a value range for X being identified for 1000 or less copies that are sold,

the statement that royalties are paid with 10 currency nits per copy,

the limitation of the territory to DE, CH, and AT,

the limitation of the language to German,

the expiration year 2005,

the indication that owner MC owns the right exclusively, and

the indication that the publishing format is not specified.

The entries in document 230 are automatically taken into account when computer 903 provides X (i.e. counts the copies) and computer 901 calculates Y (i.e. the royalties to the paid).

The right column indicates that final document 230 relates representations of right (R), the work (W) and the functional statement (F).

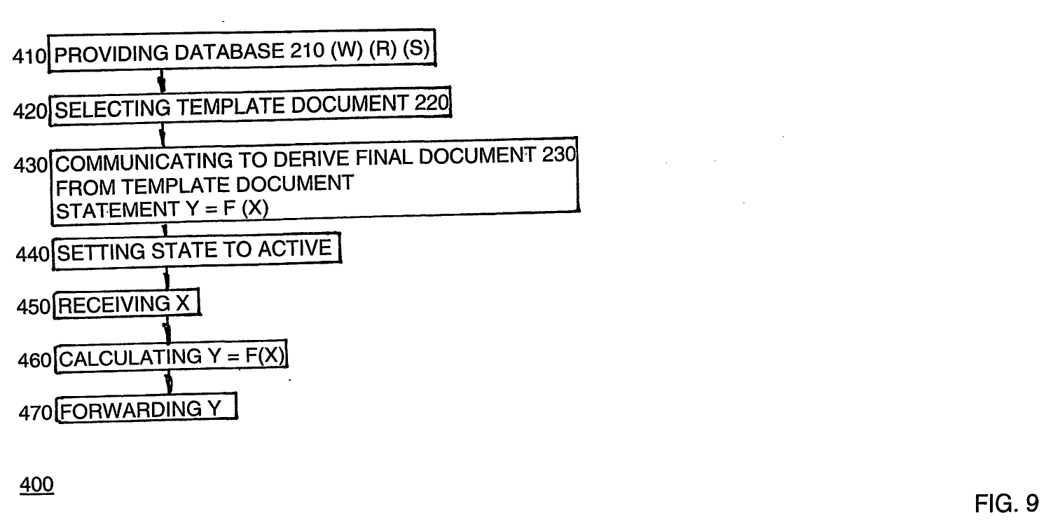

FIG. 9 is a simplified flow chart diagram of method 400 of the present invention. Method 400 for managing rights that relate to works comprises the following steps: 410 providing database, 420 selecting template document, 430 communicating to derive final document, 440 setting state to active, 450 receiving X, 460 calculating Y=F(X), and 470 forwarding Y.

More in detail, the steps are executed (by computer 901) as follows:

In step providing 410, provided are: database 210 with representations of the works W, with representations of applicable rights R for the works, and with states S is provided on computer 901.

In step selecting 420, for a given work (e.g., ALPHA), template document 220 that corresponds to the representation of the right R for the work W is selected.

In step communicating 430, computers 901 and 902 communicate to derive final document 230 from template document 220. Final document 230 has functional statement Y=F(X). The statement uses first indicator X and second indicator Y. Final document 230 is associated with database 210 (cf. FIG. 2) and relates the representations of the work W and of the right R, and the state S with the functional statement.

In step setting 440, computer 901 sets state S to active as a condition for further steps.

In step receiving 450, computer 901 receives first indicator X from computer 903.

In step calculating 460, computer 901 calculates second indicator Y according to the statement.

In step forwarding 470, computer 901 forwards second indicator Y to second computer 902.

The present invention is now summarized for computer-based system, computer-program product and article of manufacture.

Computer-based system 999 employs operatively interconnected data processing and computer means (e.g., processor, memory as in FIG. 1) for managing intellectual property rights. System 999 has—on first computer 901—database 210 with representations of works W, with representations of applicable rights R for the works, and with states S.

On the first computer 901, system 999 has template document 220 selectable to correspond to the representation of the right R for the work W.

On second computer 902, system 999 has a communicator for communicating between first computer 901 and second computer 902 to derive final document 230 from template document 220. Final document 230 has a functional statement (Y=F(X)), with first indicator X (going into computer 901) and with second indicator Y. Final document 230 is associated with database 210 and relates the representations of work W and of right R, state S and functional statement F.

On the first computer 901, system 999 has means for setting the state S to active, means for receiving 450 the first indicator X from third computer 903, means for calculating 460 the second indicator Y according to the functional statement F, and means for forwarding 460 the second indicator Y to the second computer 902.

Computer-program product 101 (cf. FIG. 2) has a plurality of code portions with cause processor 911 of computer 901 to manage intellectual property rights.

Computer-program product 101 comprises: code portions for providing 410—on first computer 901—database 210 with representations of the works W, with representations of applicable rights R for the works, and with states S; code portions for selecting 420 template document 220 that corresponds to the representation of the right R for the work W; code portions for communicating 430 between the first computer 901 and second computer 902 to derive final document 230 from template document 220, final document 230 having a functional statement with a first indicator (X) going into first computer 901 and with a second indicator (Y), final document 230 being associated with database 210 and relating the representations of the work W and of the right R, the state S and the functional statement; code portions for setting 440 the state S to active; code portions for receiving 450 the first indicator (X) from third computer 903, code portions for calculating 460 the second indicator (Y) according to the functional statement; and code portions for forwarding 460 the second indicator (Y) to second computer 902.

An article of manufacture with a computer readable medium has computer readable program code means embodied therein for managing rights that relate to works, the program code means executes the following steps: providing 410 on a first computer a database with representations of the works W, with representations of applicable rights R for the works, and with states S; for a given work ALPHA, selecting 420 a template document that corresponds to the representation of the right R for the work W; communicating 430 between the first computer and a second computer to derive a final document from the template document, the final document having a functional statement with a first indicator going into the first computer and with a second indicator, the final document being associated with the database and relating the representations of the work W and of the right R, the state S and the functional statement; setting 440 the state S to active; receiving 450 the first indicator X from a third computer; calculating 460 the second indicator Y according to the functional statement and forwarding 460 the second indicator Y to the second computer.

Glossary of Terms

“Copyrighted work” means any work that is authored and protected by U.S. and international copyright laws, including, without limitation, literary works; musical works, including any accompanying words; dramatic works, including any accompanying music; pantomimes and choreographic works; pictorial, graphic, and sculptural works; motion pictures and other audiovisual works; sound recordings; architectural works; and software.

“Medium” and “media” refer to any representation of a work, stored within computer memory, resident on CD-ROM or magnetic disks, transmitted as a digital file through email, an on-line service, the World Wide Web (WWW), or the Internet; or communicated as a file within or into a computer network, such as a LAN or WAN, and including any communication obtained through remote access, such as through application software. Advantageously, the medium is a digital medium. Traditional media like microfiche, analogue tapes, or films can also be used.

“Digital work”, refers to any work that has been reduced to a digital representation. This includes any audio, video, text, or multimedia work and any accompanying interpreter (e.g. software) that may be required for recreating the work.

“Copy of digital work”, or “copy” refers to duplicate of the work on electronic media.

Author (“creator”) A term which refers to a party who produces a work.

“Distributor” refers to a party who legitimately obtains a copy of a digital work and offers it for sale.

“Categories with attributes” conveniently divide some or all rights. Further examples are: Category “market” refers to the market for that a copy of the work is intended for (e.g., theater, music hall, audio broadcast, free television, pay television, pay-per-view television). Category “Language” refers to a natural language that used. The category “format” refers to the physical representation of the product, for example, video, digital versatile disc (DVD), hard cover book, soft cover book, book on demand, compact disc (CD), electronic book, magnetic cassette (MC), MP3-file.

References

| X, Y | indicators |
|---|---|
| F, Y = F(X) | functional statement |
| YYYY | year, such as 2001 |
| ALPHA, BETA | examples for works |
| W | work |
| S | state |
| R | right |
| 101 | computer program product |
| 210 | database |
| 220 | template document |
| 230 | final document |
| 400, 4xx | method and steps |
| 410 | providing database |
| 420 | selecting template document |
| 430 | communicating to derive final |
| | document |
| 440 | setting state to active |
| 450 | receiving |
| 460 | calculating |
| 470 | forwarding |
| 901, 902, 903 | computers |
| 999 | computer system |

1. A method (400) for managing rights that relate to works, the method comprising the following steps:
providing (410) on a first computer (901) a database (210) with representations of the works (W), with representations of applicable rights (R) for the works, and with states (S);
for a given work (ALPHA), selecting (420) a template document (220) that corresponds to the representation of the right (R) for the work (W);
communicating (430) between the first computer (901) and a second computer (902) to derive a final document (230) from the template document (220), the final document having a functional statement (Y=F(X)) with a first indicator (X) going into the first computer (901) and with a second indicator (Y), the final document (230) being associated with the database (210) and relating the representations of the work (W) and of the right (R), the state (S) and the functional statement (F);
setting (440) the state (S) to active;
receiving (450) the first indicator (X) from a third computer (903);
calculating (460) the second indicator (Y) according to the functional statement (F); and
forwarding (460) the second indicator (Y) to the second computer (902).

2. The method of claim 1, comprising the step of distributing a copy of the work, following step setting (440).

3. The method of claim 2, wherein in the receiving step, the first indicator is a numerical value representing a quantity selected from the group of:
number of physical copies of the work,
number of broadcast transmissions of the work,
time for that a physical copy of the work is available to a predetermined customer, and
the number of subscribers to copies of the work.

4. The method of claim 2, wherein the second indicator is a numerical value representing a quantity selected from the group of: royalty, agent fee, and commission.

5. The method of claim 1, further comprising a step selected from the group of:
acquiring a right,
selling a right,
managing a contract that relates to a right,
checking availability of a right,
checking two rights for collision and non-collision,
checking expiration and existence of a right,
checking contractual or statutory restrictions,
tracking utilization of a right,
alerting upon reaching a predefined threshold of the first or the second indicators,
reporting,
electronically presenting bills and payment through Internet,
delaying step setting active by a predetermined delay time, and
periodically triggering payment.

6. The method of claim 1 comprising the further step of triggering a workflow in the first computer to obtain legal clearance if a predefined condition is detected.

7. The method of claim 1 further comprising the step of parsing the database to detect events, the events selected from the group of:
the first indicator has passed a predetermined threshold;
a right is changed but a shipping a physical copy to a customer is ongoing.

8. The method of claim 9, wherein during parsing the database, events are detected that have representations in the final document.

9. The method of claim 1, further comprising the step of triggering shipment of a copy to a customer, wherein shipment comprises an action selected from the group of: shipping a physical copy of the work to a customer; and broadcasting the work.

10. The method of claim 1, wherein reading from the third computer (903) is performed by from a computer that is related to a recipient of the work, selected from the group of: radio station, broadcaster, discotheque, cinema, restaurant, distributor, media agency, customer via Internet.

11. The method of claim 1, wherein the right includes at least one of: reproduction right, broadcasting right, public performance right, adaptation right, translation right, public recitation right, public display right, distribution right, and sales right.

12. The method of claim 1, wherein one right depends on a further right.

13. The method of claim 1, wherein the rights are classified into categories with attributes.

14. The method of claim 1, wherein the template document (220) and the final document (230) comprise a contract of at least one of the following types: sales contract, purchase contract, and license contract.

15. The method of claim 14, wherein the contract is related to a further contract, selected from the group of: addendum, extension, side-letter, and contract that merges existing contracts.

16. The method of claim 1, wherein the method is performed by the first computer being a computer of a media company, and the second computer being a computer of a financial organization.

17. The method of claim 1, being performed by accessing at least one of the followings customer relationship management (CRM) functions: sales organization, sales group, sales offices, service organization, purchasing organization, and purchasers group.

18. The method of claim 1, wherein calculating the functional statement (Y=F(X)) comprises any function of the following: deactivating the state when the first indicator exceeds a predetermined number, deactivating the state after a predetermined time from activating, and deactivating the state after a right has expired.

19. The method of claim 1, wherein the work is a digital work.

20. A contract produced as the final document by the practice of the method of claim 1.

21. A computer-based system (999) employing operatively interconnected data processing and computer means for managing intellectual property rights, the system
having on a first computer (901), a database (210) with representations of the works (W), with representations of applicable rights (R) for the works, and with states (S);
having on the first computer (901), a template document (220) selectable to correspond to the representation of the right (R) for the work (W);
a communicator on a second computer (902) for communicating between the first computer (901) and the second computer (902) to derive a final document (230) from the template document (220), the final document having a functional statement (Y=F(X)), with a first indicator (X) going into the first computer (901) and with a second indicator (Y), the final document (230) being associated with the database (210) and relating the representations of the work (W) and of the right (R), the state (S) and the functional statement (F);
on the first computer (901), means for setting the state (S) to active;
on the first computer (901), means for receiving (450) the first indicator (X) from a third computer (903);
on the first computer (901), means for calculating (460) the second indicator (Y) according to the functional statement (F); and
on the first computer (901), means for forwarding (460) the second indicator (Y) to the second computer (902).

22. Computer-program product (101) having a plurality of code portions with that cause a processor of a computer to manage intellectual property rights, the computer-program product comprising:
code portions for providing (410) on a first computer (901) a database (210) with representations of the works (W), with representations of applicable rights (R) for the works, and with states (S);
code portions for selecting (420) a template document (220) that corresponds to the representation of the right (R) for the work (W);
code portions for communicating (430) between the first computer (901) and a second computer (902) to derive a final document (230) from the template document (220), the final document having a functional statement (Y=F(X)), with a first indicator (X) going into the first computer (901) and with a second indicator (Y), the final document (230) being associated with the database (210) and relating the representations of the work (W) and of the right (R), the state (S) and the functional statement (F);
code portions for setting (440) the state (S) to active;
code portions for receiving (450) the first indicator (X) from a third computer (903);
code portions for calculating (460) the second indicator (Y) according to the functional statement (F); and
code portions for forwarding (460) the second indicator (Y) to the second computer (902).

23. An article of manufacture with a computer readable medium having computer readable program code means embodied therein for managing rights that relate to works, the program code means executing the following steps:
providing (410) on a first computer (901) a database (210) with representations of the works (W), with representations of applicable rights (R) for the works, and with states (S);
for a given work (ALPHA), selecting (420) a template document (220) that corresponds to the representation of the right (R) for the work (W);
communicating (430) between the first computer (901) and a second computer (902) to derive a final document (230) from the template document (220), the final document having a functional statement (Y=F(X)), with a first indicator (X) going into the first computer (901) and with a second indicator (Y), the final document (230) being associated with the database (210) and relating the representations of the work (W) and of the right (R), the state (S) and the functional statement (F);
setting (440) the state (S) to active;
receiving (450) the first indicator (X) from a third computer (903);
calculating (460) the second indicator (Y) according to the functional statement (F); and
forwarding (460) the second indicator (Y) to the second computer (902).
